(19) United States
(12) Patent Application Publication
(10) Pub. No.: US 2022/0413545 A1
(43) Pub. Date: Dec. 29, 2022

(54) Head-Mounted Display

(71) Applicant: Quanta Computer Inc., Taoyuan City (TW)

(72) Inventors: Hung-Yu Lin, Taoyuan City (TW); Chun-Feng Yeh, Taoyuan City (TW); Jia-Cheng Chang, Taoyuan City (TW); Bing-Kai Huang, Taoyuan City (TW); Chun-Nan Huang, Taoyuan City (TW); Chun-Lung Chen, Taoyuan City (TW)

(73) Assignee: Quanta Computer Inc., Taoyuan City (TW)

(21) Appl. No.: 17/480,626

(22) Filed: Sep. 21, 2021

(30) Foreign Application Priority Data
Jun. 29, 2021 (TW) 110207589

(51) Int. Cl. G06F 1/16

(52) U.S. Cl. CPC G06F 1/163

(57) ABSTRACT

A head-mounted display includes a face-abutting frame, a first adjustable structure, a second adjustable structure and a display module. The face-abutting frame has a first side and a second side opposite to each other. The first side abuts against a face of a user. The face-abutting frame defines a space corresponding to eyes of the user. The first adjustable structure connects with the second side. The second adjustable structure connects with the second side and defines the space with the first adjustable structure. The second adjustable structure movably and mechanically connects with the first adjustable structure. The display module corresponds to the space and movably and mechanically connects with the first adjustable structure. The first and the second adjustable structures can move close to or away from each other. The display module and the first adjustable structure can move close to or away from each other.

### RELATED APPLICATIONS

This application claims priority to Taiwanese Application Serial Number 110207589 filed Jun. 29, 2021, which is herein incorporated by reference.

### BACKGROUND

### Technical Field

The present disclosure relates to head-mounted displays (HMDs).

### Description of Related Art

With the advancement of technology in the society, the technology of virtual reality (VR) is also upgraded everyday. Through wearing a head-mounted display, a virtual environment is fallen into the field of vision of the user. Moreover, the user can interact with the objects in this virtual environment, making the user really feel like being in a three-dimensional virtual world.

In order to allow the user to be better involved in the virtual environment when using the head-mounted display, the way to improve the comfort of wearing the head-mounted display is undoubtedly a direction of development which the industry highly concerns.

### SUMMARY

A technical aspect of the present disclosure is to provide a head-mounted display, which can effectively avoid from interfering with the glasses of the user and allow the user to conveniently adjust the eye relief, such that the user can feel the optimum field of view (FOV) of the head-mounted display.

According to an embodiment of the present disclosure, a head-mounted display includes a face-abutting frame, a first adjustable structure, a second adjustable structure and a display module. The face-abutting frame has a first side and a second side. The first side and the second side are opposite to each other. The first side is configured to abut against a face of a user. The face-abutting frame defines a space. The space corresponds to eyes of the user. The first adjustable structure is connected with the second side. The second adjustable structure is connected with the second side. The second adjustable structure defines the space together with the first adjustable structure. The second adjustable structure is movably and mechanically connected with the first adjustable structure. The display module corresponds to the space. The display module is movably and mechanically connected with the first adjustable structure. The first adjustable structure and the second adjustable structure can be moved close to each other or away from each other. The display module and the first adjustable structure can be moved close to each other or away from each other.

In one or more embodiments of the present disclosure, the first adjustable structure and the second adjustable structure are movably and mechanically connected along a first direction. The display module and the first adjustable structure are movably and mechanically connected along a second direction. The first direction is substantially perpendicular with the second direction.

In one or more embodiments of the present disclosure, the first adjustable structure includes a first body and a first teeth strip. The first teeth strip is connected with the first body. The first teeth strip at least partially extends along the first direction. The first teeth strip has a plurality of first tooth. The first teeth are arranged along the first direction. The first teeth at least partially face to the first body. The second adjustable structure includes a second body and a second teeth strip. The second teeth strip is connected with the second body. The second teeth strip at least partially extends along the first direction. The second teeth strip is at least partially located between the first body and the first teeth strip. The second teeth strip has a plurality of second tooth. The second teeth are arranged along the first direction. The second teeth at least partially face to the first teeth strip. The head-mounted display further includes a first gear. The first gear is coupled between the first teeth and the second teeth along the second direction.

In one or more embodiments of the present disclosure, the head-mounted display further includes an outer casing and a first rotating button. The outer casing at least partially covers the display module, the first adjustable structure and the second adjustable structure. The outer casing has a first through hole. The first rotating button at least partially penetrates through the first through hole. The first rotating button is connected with the first gear along a first axis. The first gear is configured to rotate about the first axis.

In one or more embodiments of the present disclosure, the head-mounted display further includes a controller and a first driver. The controller is signally connected with the first driver. The first driver is connected with the first gear. The first driver is configured to rotate the first gear.

In one or more embodiments of the present disclosure, the first adjustable structure includes a first body and a third teeth strip. The third teeth strip is connected with the first body. The third teeth strip at least partially extends along the second direction. The third teeth strip has a plurality of third tooth. The third teeth are arranged along the second direction. The display module includes a housing and a fourth teeth strip. The fourth teeth strip is connected with an outer surface of the housing. The fourth teeth strip at least partially extends along the second direction. The fourth teeth strip has a plurality of fourth tooth. The fourth teeth are arranged along the second direction. The fourth teeth at least partially face to the third teeth strip. The head-mounted display further includes a second gear. The second gear is coupled between the third teeth and the fourth teeth.

In one or more embodiments of the present disclosure, the second gear is coupled between the third teeth and the fourth teeth along a third direction. The third direction is substantially perpendicular with the first direction and the second direction.

In one or more embodiments of the present disclosure, the head-mounted display further includes an outer casing and a second rotating button. The outer casing at least partially covers the display module, the first adjustable structure and the second adjustable structure. The outer casing has a second through hole. The second rotating button at least partially penetrates through the second through hole. The second rotating button is connected with the second gear along a second axis. The second gear is configured to rotate about the second axis.

In one or more embodiments of the present disclosure, the head-mounted display further includes a controller and a second driver. The controller is signally connected with the second driver. The second driver is connected with the second gear. The second driver is configured to rotate the second gear.

In one or more embodiments of the present disclosure, when the first adjustable structure and the second adjustable structure are moved away from each other, the face-abutting frame is at least partially elongated elastically.

When compared with the prior art, the above-mentioned embodiments of the present disclosure have at least the following advantage:

(1) Since the user can adjust the distance between the first adjustable structure and the second adjustable structure in a simple and easy manner, even if the user is wearing a pair of glasses, the condition that the head-mounted display interferes with the glasses when using the head-mounted display can be effectively avoided.

(2) Since the user can adjust the distance between the first adjustable structure and the display module in a simple and easy manner, when using the head-mounted display, the user can conveniently adjust the distance between the pupils of his eyes and the display screen of the display module, namely the eye relief, such that the user can feel the optimum field of view (FOV) of the head-mounted display.

### BRIEF DESCRIPTION OF THE DRAWINGS

The disclosure can be more fully understood by reading the following detailed description of the embodiments, with reference made to the accompanying drawings as follows:

FIG. 1 is a schematic view of a head-mounted display according to an embodiment of the present disclosure;

FIG. 2 is an exploded view of the head-mounted display of FIG. 1;

FIG. 3 is a schematic view of a portion of the structure of the head-mounted display of FIG. 1;

FIG. 4 is a top view of the head-mounted display of FIG. 3, in which the first adjustable structure and the second adjustable structure are moved close to each other;

FIG. 5 is a top view of the head-mounted display of FIG. 3, in which the first adjustable structure and the second adjustable structure are moved away from each other;

FIG. 6 is a schematic view of a portion of the structure of the head-mounted display of FIG. 1;

FIG. 7 is a side view of the head-mounted display of FIG. 6, in which the display module and the first adjustable structure are moved close to each other;

FIG. 8 is a side view of the head-mounted display of FIG. 6, in which the display module and the first adjustable structure are moved away from each other;

FIG. 9 is a partial schematic view of a head-mounted display according to another embodiment of the present disclosure, in which the first gear is mechanically connected with the first driver; and

FIG. 10 is a partial schematic view of a head-mounted display according to a further embodiment of the present disclosure, in which the second gear is mechanically connected with the second driver.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

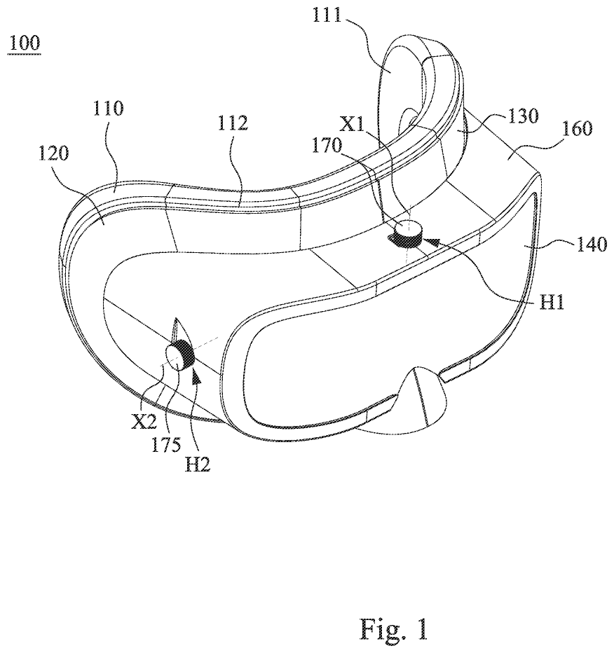

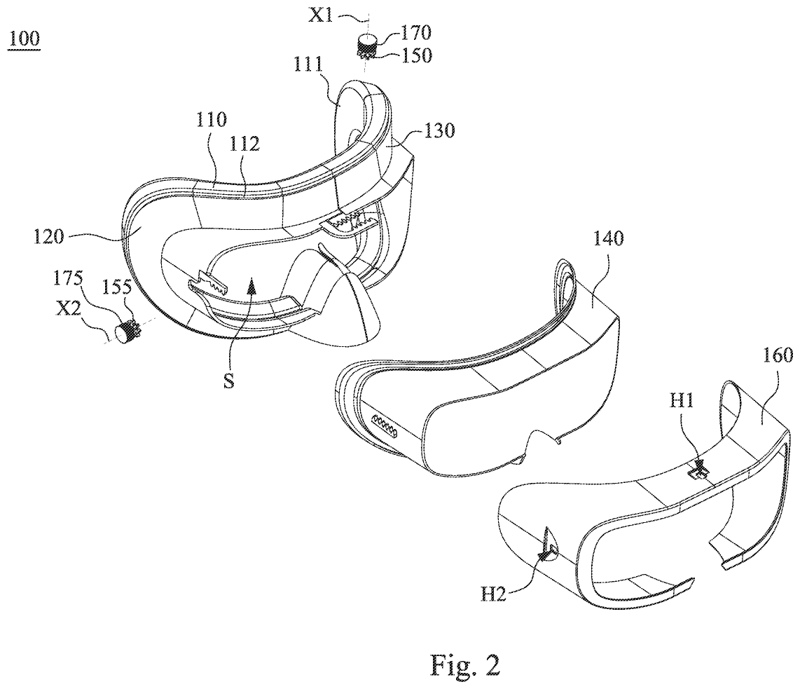

Reference is made to FIGS. 1-2. FIG. 1 is a schematic view of a head-mounted display 100 according to an embodiment of the present disclosure. FIG. 2 is an exploded view of the head-mounted display 100 of FIG. 1. In this embodiment, as shown in FIGS. 1-2, a head-mounted display 100 includes a face-abutting frame 110, a first adjustable structure 120, a second adjustable structure 130, a display module 140 and an outer casing 160. The face-abutting frame 110 has a first side 111 and a second side 112. The first side 111 and the second side 112 are opposite to each other. The first side 111 is configured to abut against a face of a user (not shown). The face-abutting frame 110 defines a space S. The space S corresponds to eyes of the user. The first adjustable structure 120 is connected with the second side 112 of the face-abutting frame 110. The second adjustable structure 130 is connected with the second side 112 of the face-abutting frame 110. The second adjustable structure 130 is movably and mechanically connected with the first adjustable structure 120. The second adjustable structure 130 defines the space S together with the first adjustable structure 120. Moreover, the display module 140 corresponds to the space S. The display module 140 is configured to provide an image towards the space S by its display screen (not shown) such that the user can see. In practical applications, the display module 140 can be a virtual reality (VR) display module 140 which provides a VR image to the user. Moreover, to be specific, the display module 140 is movably and mechanically connected with the first adjustable structure 120. On the other hand, the outer casing 160 at least partially covers the display module 140, the first adjustable structure 120 and the second adjustable structure 130.

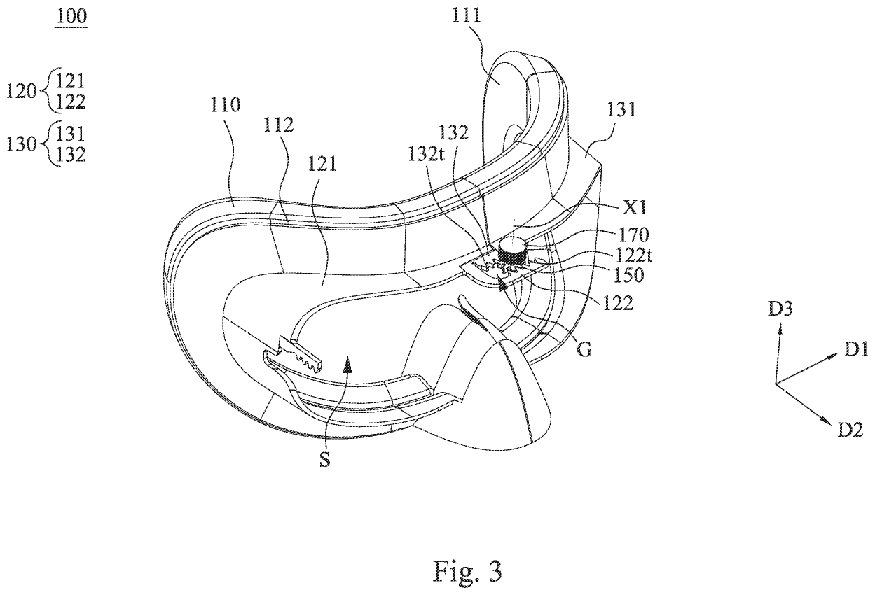

Reference is made to FIG. 3. FIG. 3 is a schematic view of a portion of the structure of the head-mounted display 100 of FIG. 1. In this embodiment, as shown in FIG. 3, the first adjustable structure 120 includes a first body 121 and a first teeth strip 122. The first teeth strip 122 is connected with the first body 121. The first teeth strip 122 at least partially extends along a first direction D1. The first teeth strip 122 has a plurality of first tooth 122t. The first teeth 122t are arranged along the first direction D1. The first teeth 122t at least partially face to the first body 121. In other words, the first teeth 122t and the first body 121 define a gap G therebetween. On the other hand, the second adjustable structure 130 includes a second body 131 and a second teeth strip 132. The second teeth strip 132 is connected with the second body 131. The second teeth strip 132 at least partially extends along the first direction D1. The second teeth strip 132 is at least partially located between the first body 121 and the first teeth strip 122. This means, the second teeth strip 132 is at least partially located in the gap G. The second teeth strip 132 has a plurality of second tooth 132t. The second teeth 132t are arranged along the first direction D1. The second teeth 132t at least partially face to the first teeth strip 122. The head-mounted display 100 further includes a first gear 150. The first gear 150 is coupled between the first teeth 122t and the second teeth 132t along a second direction D2. The first direction D1 is substantially perpendicular with the second direction D2.

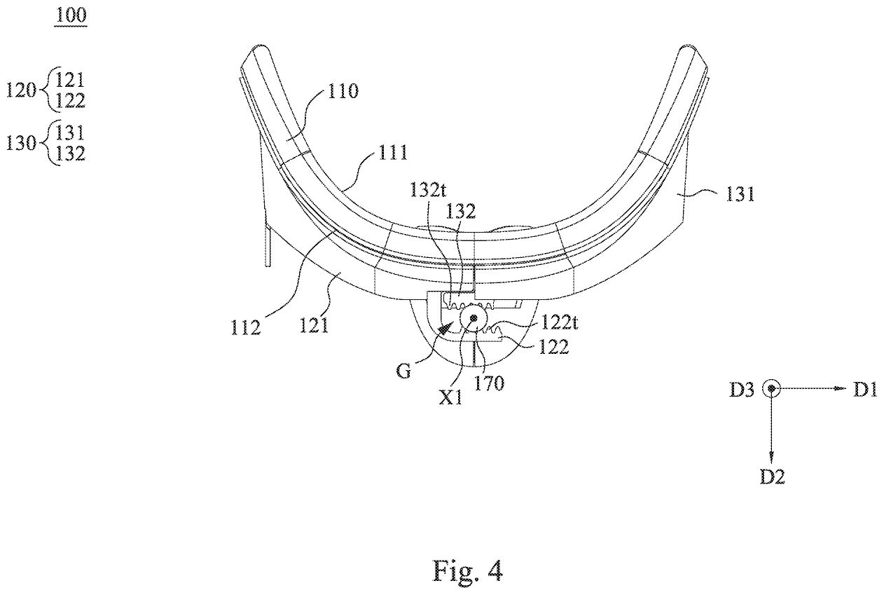

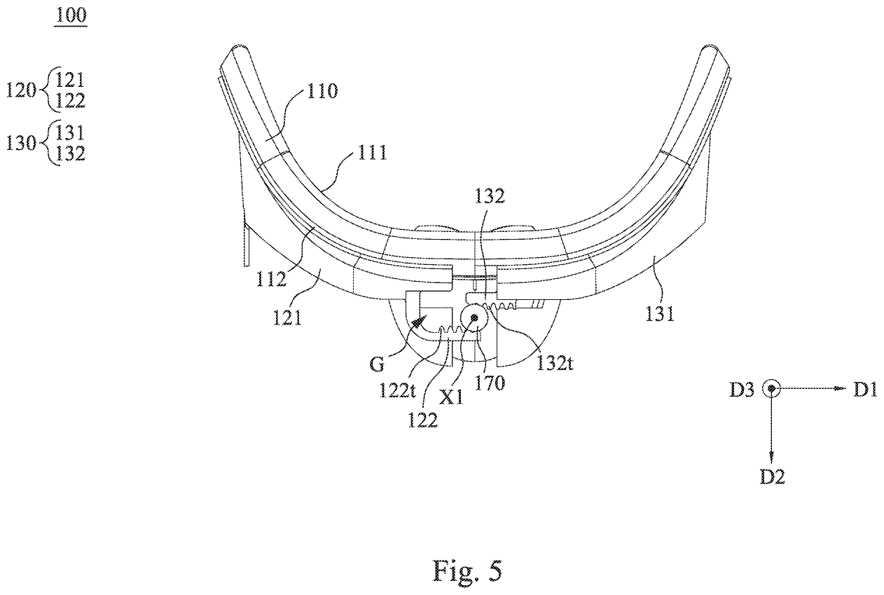

Reference is made to FIGS. 4-5. FIG. 4 is a top view of the head-mounted display 100 of FIG. 3, in which the first adjustable structure 120 and the second adjustable structure 130 are moved close to each other. FIG. 5 is a top view of the head-mounted display 100 of FIG. 3, in which the first adjustable structure 120 and the second adjustable structure 130 are moved away from each other. In this embodiment, as shown in FIGS. 4-5, the first adjustable structure 120 and the second adjustable structure 130 are movably and mechanically connected along the first direction D1. Through the rotation of the first gear 150 (please see FIG. 3), the first adjustable structure 120 and the second adjustable structure 130 can be moved close to each other or away from each other along the first direction D1.

In practical applications, in order to provide a higher level of comfortability to the user and to make the face-abutting frame 110 to be more fit to the face of the user, the face-abutting frame 110 can be of a soft material, such as foam, soft plastic or the like. Therefore, when the first adjustable structure 120 and the second adjustable structure 130 are moved away from each other, the face-abutting frame 110 is at least partially elongated elastically.

Furthermore, as shown in FIGS. 1-5, the head-mounted display 100 further includes a first rotating button 170. In this embodiment, the outer casing 160 has a first through hole H1 (please see FIGS. 1-2). The first rotating button 170 at least partially penetrates through the first through hole H1. The first rotating button 170 is connected with the first gear 150 along a first axis X1. The first gear 150 is configured to rotate about the first axis X1. As the first rotating button 170 is rotated by the fingers of the user, the first gear 150 rotates about the first axis X1 with the first rotating button 170, and the first teeth strip 122 of the first adjustable structure 120 and the second teeth strip 132 of the second adjustable structure 130 are respectively driven by the first gear 150, such that the first adjustable structure 120 and the second adjustable structure 130 are moved close to or away from each other along the first direction D1. In other words, the user can adjust the distance between the first adjustable structure 120 and the second adjustable structure 130 in a simple and easy manner. Therefore, even if the user is wearing a pair of glasses, the condition that the head-mounted display 100 interferes with the glasses when using the head-mounted display 100 can be effectively avoided.

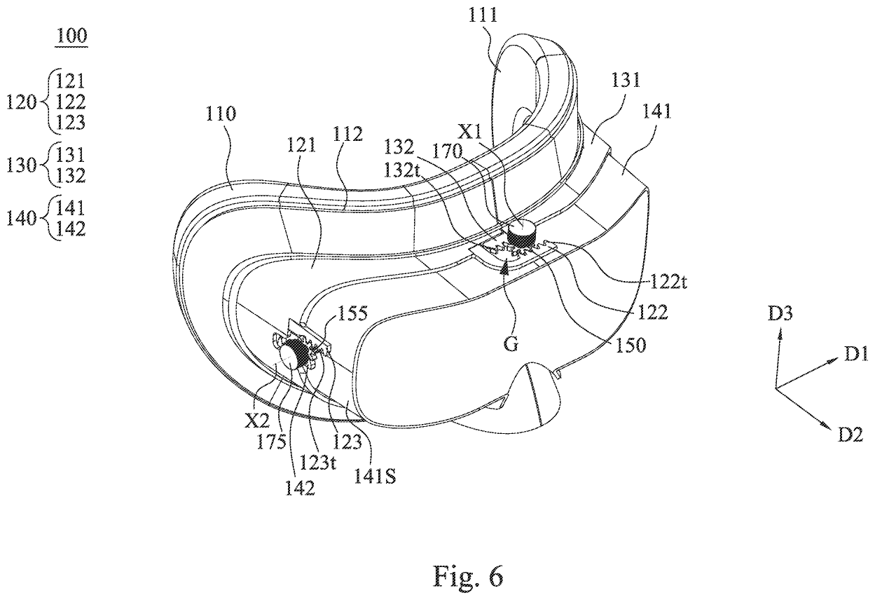

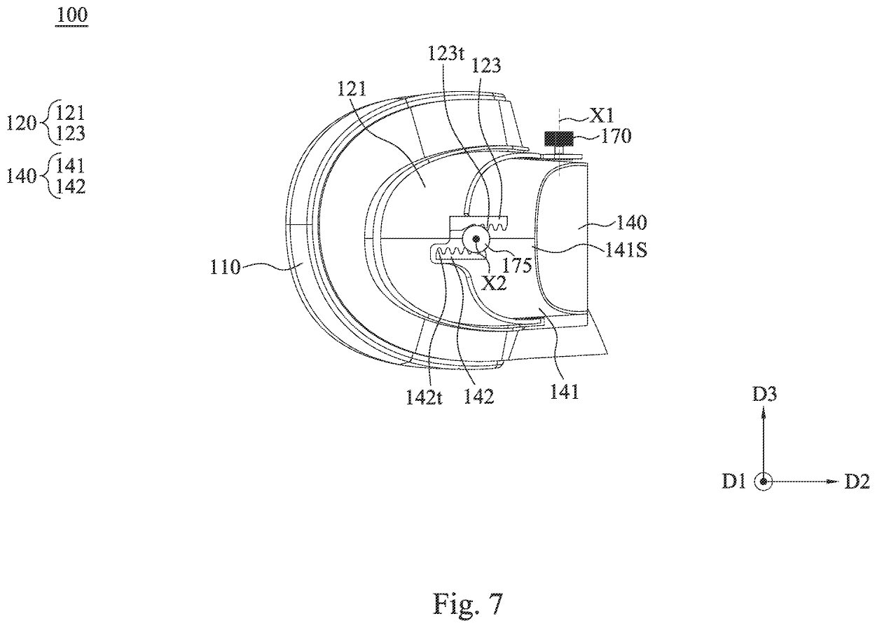

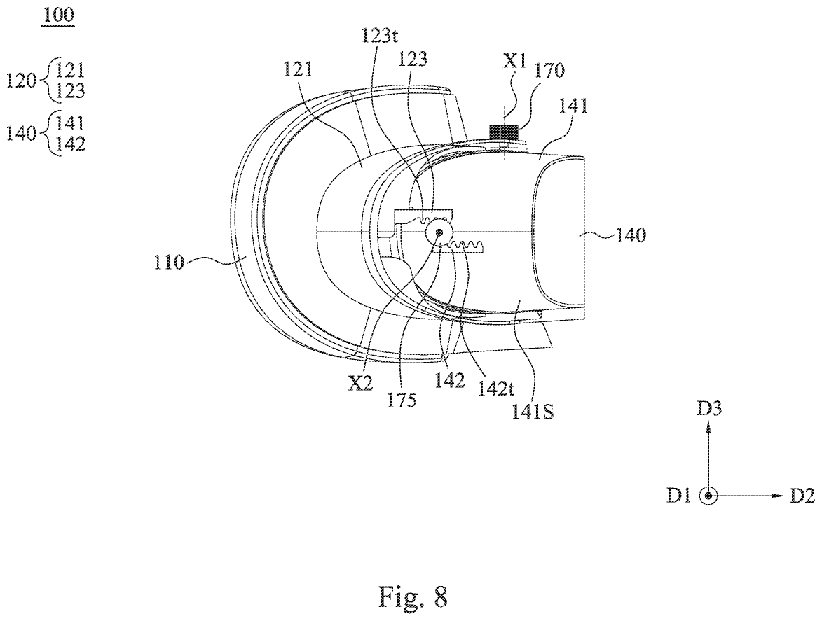

Reference is made to FIG. 6. FIG. 6 is a schematic view of a portion of the structure of the head-mounted display 100 of FIG. 1. In this embodiment, as shown in FIG. 6, the first adjustable structure 120 further includes a third teeth strip 123. The third teeth strip 123 is connected with the first body 121. The third teeth strip 123 at least partially extends along the second direction D2. The third teeth strip 123 has a plurality of third tooth 123t. The third teeth 123t are arranged along the second direction D2. Moreover, the display module 140 includes a housing 141 and a fourth teeth strip 142. The fourth teeth strip 142 is connected with an outer surface 141s of the housing 141. The fourth teeth strip 142 at least partially extends along the second direction D2. The fourth teeth strip 142 has a plurality of fourth tooth 142t (please see FIGS. 7-8). The fourth teeth 142t are arranged along the second direction D2. The fourth teeth 142t at least partially face to the third teeth strip 123. The head-mounted display 100 further includes a second gear 155. The second gear 155 is coupled between the third teeth 123t and the fourth teeth 142t along a third direction D3. The third direction D3 is substantially perpendicular with the first direction D1 and the second direction D2.

Reference is made to FIGS. 7-8. FIG. 7 is a side view of the head-mounted display 100 of FIG. 6, in which the display module 140 and the first adjustable structure 120 are moved close to each other. FIG. 8 is a side view of the head-mounted display 100 of FIG. 6, in which the display module 140 and the first adjustable structure 120 are moved away from each other. In this embodiment, as shown in FIGS. 7-8, the display module 140 and the first adjustable structure 120 are movably and mechanically connected along the second direction D2. Through the rotation of the second gear 155 (please see FIG. 6), the display module 140 and the first adjustable structure 120 can be moved close to each other or away from each other along the first direction D1.

Furthermore, as shown in FIGS. 1-2 and 6-8, the head-mounted display 100 further includes a second rotating button 175. In this embodiment, the outer casing 160 has a second through hole H2. The second rotating button 175 at least partially penetrates through the second through hole H2. The second rotating button 175 is connected with the second gear 155 along a second axis X2. The second gear 155 is configured to rotate about the second axis X2. As the second rotating button 175 is rotated by the fingers of the user, the second gear 155 rotates about the second axis X2 with the second rotating button 175, and the third teeth strip 123 of the first adjustable structure 120 and the fourth teeth strip 142 of the display module 140 are respectively driven by the second gear 155, such that the first adjustable structure 120 and the display module 140 are moved close to or away from each other along the second direction D2. In other words, the user can adjust the distance between the first adjustable structure 120 and the display module 140 in a simple and easy manner. Therefore, when using the head-mounted display 100, the user can conveniently adjust the distance between the pupils of his eyes and the display screen of the display module 140, namely the eye relief, such that the user can feel the optimum field of view (FOV) of the head-mounted display 100.

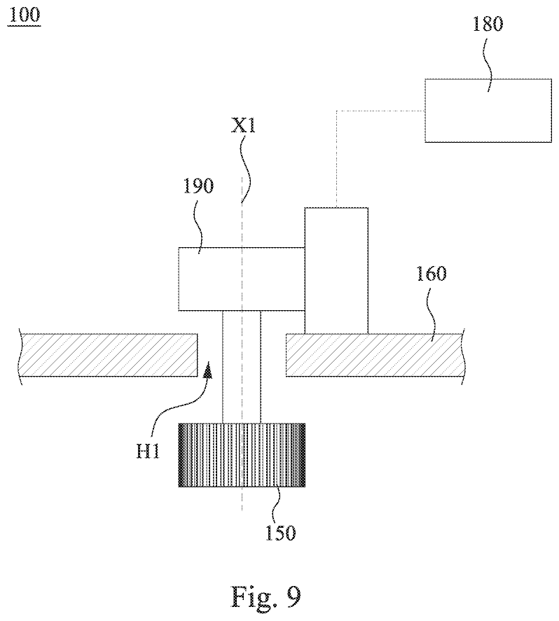

Reference is made to FIG. 9. FIG. 9 is a partial schematic view of a head-mounted display 100 according to another embodiment of the present disclosure, in which the first gear 150 is mechanically connected with the first driver 190. In this embodiment, the head-mounted display 100 further includes a controller 180 and a first driver 190. For example, as shown in FIG. 9, the first driver 190 is disposed on the outer casing 160, and the first driver 190 is connected with the first gear 150. The first driver 190 is configured to rotate the first gear 150 about the first axis X1. The controller 180 is signally connected with the first driver 190. When the first driver 190 receives a signal from the controller 180, the first driver 190 starts up and rotates the first gear 150 about the first axis X1, such that the first adjustable structure 120 and the second adjustable structure 130 are moved close to or away from each other along the first direction D1 (please see FIGS. 3-5).

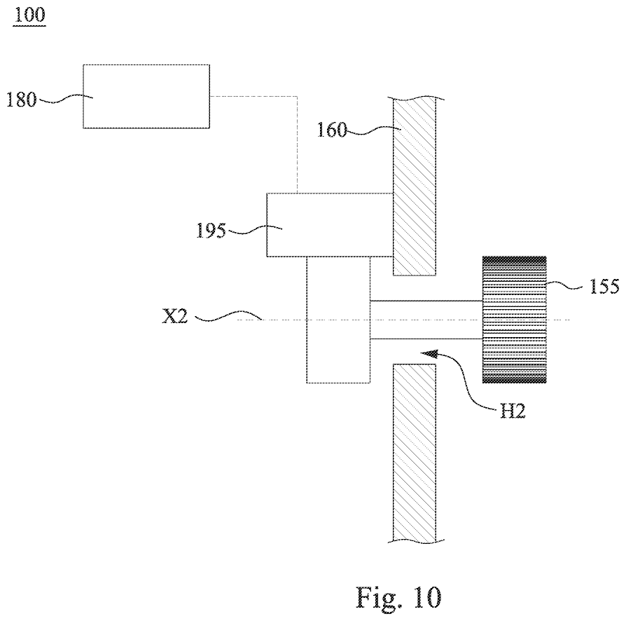

Reference is made to FIG. 10. FIG. 10 is a partial schematic view of a head-mounted display 100 according to a further embodiment of the present disclosure, in which the second gear 155 is mechanically connected with the second driver 195. In this embodiment, the head-mounted display 100 further includes a second driver 195. For example, as shown in FIG. 10, the second driver 195 is disposed on the outer casing 160, and the second driver 195 is connected with the second gear 155. The second driver 195 is configured to rotate the second gear 155 about the second axis X2. The controller 180 is signally connected with the second driver 195. When the second driver 195 receives a signal from the controller 180, the second driver 195 starts up and rotates the second gear 155 about the second axis X2, such that the display module 140 and the first adjustable structure 120 are moved close to or away from each other along the first direction D1 (please see FIGS. 6-8). Furthermore, according to the actual situations, the first driver 190 and the second driver 195 are signally connected to the same controller 180.

In conclusion, when compared with the prior art, the aforementioned embodiments of the present disclosure have at least the following advantage:

(1) Since the user can adjust the distance between the first adjustable structure and the second adjustable structure in a simple and easy manner, even if the user is wearing a pair of glasses, the condition that the head-mounted display interferes with the glasses when using the head-mounted display can be effectively avoided.

(2) Since the user can adjust the distance between the first adjustable structure and the display module in a simple and easy manner, when using the head-mounted display, the user can conveniently adjust the distance between the pupils of his eyes and the display screen of the display module, namely the eye relief, such that the user can feel the optimum field of view (FOV) of the head-mounted display.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A head-mounted display, comprising:
a face-abutting frame having a first side and a second side opposite to each other, the first side being configured to abut against a face of a user, the face-abutting frame defining a space, the space corresponding to eyes of the user;
a first adjustable structure connected with the second side;
a second adjustable structure connected with the second side, the second adjustable structure defining the space together with the first adjustable structure and being movably and mechanically connected with the first adjustable structure; and
a display module corresponding to the space, the display module being movably and mechanically connected with the first adjustable structure,
wherein the first adjustable structure and the second adjustable structure can be moved close to each other or away from each other, and the display module and the first adjustable structure can be moved close to each other or away from each other.

2. The head-mounted display of claim 1, wherein the first adjustable structure and the second adjustable structure are movably and mechanically connected along a first direction, the display module and the first adjustable structure are movably and mechanically connected along a second direction, the first direction is substantially perpendicular with the second direction.

3. The head-mounted display of claim 2, wherein the first adjustable structure comprises a first body and a first teeth strip, the first teeth strip is connected with the first body and at least partially extends along the first direction, the first teeth strip has a plurality of first tooth, the first teeth are arranged along the first direction and at least partially face to the first body, the second adjustable structure comprises a second body and a second teeth strip, the second teeth strip is connected with the second body and at least partially extends along the first direction, the second teeth strip is at least partially located between the first body and the first teeth strip, the second teeth strip has a plurality of second tooth, the second teeth are arranged along the first direction and at least partially face to the first teeth strip,
the head-mounted display further comprises:
a first gear coupled between the first teeth and the second teeth along the second direction.

4. The head-mounted display of claim 3, further comprising an outer casing and a first rotating button, the outer casing at least partially covers the display module, the first adjustable structure and the second adjustable structure, the outer casing has a first through hole, the first rotating button at least partially penetrates through the first through hole and is connected with the first gear along a first axis, the first gear is configured to rotate about the first axis.

5. The head-mounted display of claim 3, further comprising a controller and a first driver, the controller is signally connected with the first driver, the first driver is connected with the first gear and is configured to rotate the first gear.

6. The head-mounted display of claim 2, wherein the first adjustable structure comprises a first body and a third teeth strip, the third teeth strip is connected with the first body and at least partially extends along the second direction, the third teeth strip has a plurality of third tooth, the third teeth are arranged along the second direction, the display module comprises a housing and a fourth teeth strip, the fourth teeth strip is connected with an outer surface of the housing and at least partially extends along the second direction, the fourth teeth strip has a plurality of fourth tooth, the fourth teeth are arranged along the second direction and at least partially face to the third teeth strip,
the head-mounted display further comprises:
a second gear coupled between the third teeth and the fourth teeth.

7. The head-mounted display of claim 6, wherein the second gear is coupled between the third teeth and the fourth teeth along a third direction, the third direction is substantially perpendicular with the first direction and the second direction.

8. The head-mounted display of claim 6, further comprising an outer casing and a second rotating button, the outer casing at least partially covers the display module, the first adjustable structure and the second adjustable structure, the outer casing has a second through hole, the second rotating button at least partially penetrates through the second through hole and is connected with the second gear along a second axis, the second gear is configured to rotate about the second axis.

9. The head-mounted display of claim 6, further comprising a controller and a second driver, the controller is signally connected with the second driver, the second driver is connected with the second gear and is configured to rotate the second gear.

10. The head-mounted display of claim 1, wherein when the first adjustable structure and the second adjustable structure are moved away from each other, the face-abutting frame is at least partially elongated elastically.
